(19) United States
(12) Patent Application Publication
(10) Pub. No.: US 2006/0084743 A1
(43) Pub. Date: Apr. 20, 2006

(54) Composition comprising polymer and silicone rubber

(76) Inventor: John Chu Chen, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/969,597

(22) Filed: Oct. 20, 2004

(51) Int. Cl. C08K 9/04; B60C 1/00

(52) U.S. Cl. 524/445; 524/492

(57) ABSTRACT

A product is disclosed which comprises, or produced from, a substrate having coated, encased, impregnated, laminated, coextruded, calendered, or applied with a composition in which the substrate can be plastics, paper, wood, coating, fabric, metal, leather, or combinations of two or more thereof and the composition can comprise or be produced from an organic polymer, a silicone rubber, a metal compound, and optionally an inorganic filler.

### FIELD OF THE INVENTION

The present invention relates to a composition which includes an organic polymer, a silicone rubber, and a metal compound.

### BACKGROUND OF THE INVENTION

Several patents and publications are cited in this description in order to more fully describe the state of the art to which this invention pertains. The entire disclosure of each of these patents and publications is incorporated by reference herein.

Much human suffering and economic loss have been prevented by the use of various materials in the construction of vehicles and buildings, whether residential or commercial. Historically, great effort has been devoted to the development of new materials. In particular, improving the flame resistance of polymers has been an important goal, because polymers are carbonaceous materials that are efficient fuel for combustion, and also because polymers have many desirable properties that lead to their inclusion in increasing number and quantity in the structures and objects that surround us.

For example, polyvinyl chloride (PVC) and polytetrafluoroethylene (PTFE) are examples of fire resistant halogenated polymers. In theory, halogenated polymers are because, when combusted, they produce X⁵⁰⁰ radicals, where X is a halogen. The X^{•}radicals are believed to slow combustion by reactions leading to the quenching of more reactive radicals such as H^{•}and OH^{•}in the plasma phase. Disadvantageously, however, to the extent that the halogenated polymers do burn, the combustion products include toxic and/or corrosive substances, such as hydrogen chloride, hydrogen fluoride, and halogenated aliphatic and aromatic compounds.

Also for example, a silicone rubber with no additives will resist combustion in air, and silicone rubbers usually do not drip during burning. Therefore, silicone rubbers have also been used to impart flame resistance to polymers.

Inorganic fillers, such as clays and talcs, can be added to polymers to provide structural reinforcement and to reduce cost. Fillers are normally selected for chemical compatibility with the polymer. Certain inorganic fillers are also known to have capabilities, however. For example, calcium carbonate (CaCO₃) has been used as a component of a polymer composition. See, e.g., EP Patent Applications 0 333 514, 0 393 959, and 1 316 581.

Furthermore, certain metal hydroxides and hydrated metal compound, such as aluminum hydroxide (Al(OH)₃), alumina trihydrate (Al₂O₃.3H₂O, “ATH”), magnesium hydroxide (Mg(OH)₂, “MH”), are also known for use as flame retardants in polymeric materials. Advantageously, the decomposition products of ATH and MH are non-toxic. When burned, these metal compounds decompose endothermically to yield metal oxides and water. The heat sink thus provided reduces the temperature of the polymer body. The water dilutes the combustion gases, thus depriving the flame of oxygen. Finally, the metal oxide decomposition products may form an insulating layer on the surface of the polymer.

In summary, fire poses numerous grave dangers to life and health, and is also destructive to buildings, vehicles, and infrastructures. Therefore, there is an ongoing need for compositions that are effective, versatile, easily processed, and economically attractive.

### SUMMARY OF THE INVENTION

A composition comprises an organic polymer, a silicone rubber, a metal compound, and optionally inorganic filler in which the metal compound is metal hydroxide or hydrated metal compound or both.

A product comprises, or is produced from, a substrate having applied thereon or therewith a composition disclosed above.

### DETAILED DESCRIPTION OF THE INVENTION

Suitable organic polymers for use can include, without limitation, polyurethanes, including polyether polyurethanes, polyester polyurethanes, polyurethaneureas, and their copolymers; polyvinylpyrrolidones; polyvinyl alcohols; polyethylene glycols and their copolymers; polypropylene glycols and their copolymers; polyoxyethylenes and their copolymers; polyacrylic acid; polyacrylamides; polyolefins such as polyethylene and polypropylene; ethylene copolymers with at least one of the comonomers from (meth)acrylic acid, alkyl (meth)acrylate, vinyl acetate, CO, vinyl silane, epoxy containing (meth)acrylate, maleic anhydride, maleic acid, maleic acid mono-ester; ethylene ionomers, halogenated polyolefins such as polytetrafluoroethylene; polyvinyl chloride (PVC); polyvinylacetate, poly(ethylene terephthalate); polyesters; polyamides; polyureas; polystyrene; styrene-block copolymers; polymethyl methacrylate; acrylic-butadiene-styrene copolymers; natural and synthetic rubbers; acrylonitrile rubber; copolymers thereof of mixtures of two or more thereof; and the like.

Preferred organic polymers include ethylene copolymers. Preferred ethylene copolymers include an ethylene/carboxylic acid copolymer having from 9 to 25 weight percent acrylic or methacrylic acid, and optionally up to 40 weight percent alkyl acrylate or methacrylate whose alkyl group has from 1 to 8 carbon atoms and the corresponding ionomers, and ethylene copolymers with at least one of the comonomers from (meth)acrylic acid, alkyl (meth)acrylate, vinyl acetate, CO, epoxy containing (meth)acrylate, vinyl silane, maleic anhydride, maleic acid, maleic acid mono-ester, and the like. Acrylic acid and acrylates are more preferred. Alkyl groups comprising butyl, ethyl, and/or methyl groups are also more preferred. Still more preferably, the alkyl groups comprise butyl groups.

Methods of preparing the polymers or copolymers are well known in the art. For example, acid copolymers may be prepared by the method disclosed in U.S. Pat. No. 4,351,931, U.S. Pat. No. 5,028,674, and U.S. Pat. No. 4,248,990.

Several preferred ethylene copolymers for use in the present invention are commercially available. These include Elvaloy® AC polymers, such as Elvaloy® AC4170, AC3717, AC3108, AC1125, AC2715, AC3427, Elvaloy® AM-L, Elvaloy® 741, Elvaloy® HP551; Elvaloy 4051, Elvaloy® AS, Elvax® 3174, Elvax® 3170, Elvax® 3180, Nucrel® 925, Surlyn® 8527, Surlyn® 8940, Surlyn® 8020, Surlyn® 8120, etc., all available from E.I. du Pont de Nemours & Co. (DuPont) of Wilmington, Del.

Preferably, the composition comprises a finite amount up to about 70 wt %, or 0.001 to about 70 wt %, or about 10 wt % to about 60 wt %, or about 20 wt % to about 45 wt % of the organic polymer, based on the weight of the composition.

Silicone rubber can include elastomeric and non-elastomeric compounds containing silicon, such as silicone gum rubber, silicone oil, siloxanes, and polysiloxanes. Suitable silicone rubbers may be silicone resins, gums, or fluids and can include organosiloxane compounds comprising chemically combined siloxy units selected from the group consisting of R₃SiO_{0.5}, R₂SiO, RSiO_{1.5}, RR¹SiO, SiO₂, and combinations thereof. R and R¹ independently represent radicals selected from the group consisting of saturated or unsaturated monovalent hydrocarbons, hydrogen, hydroxyl, alkoxy, aryl, vinyl, or allyl.

For example, methoxy-terminated polyakylsiloxanes and hydroxy-terminated polydimethylsiloxane can be used. Examples of polyorganosiloxanes include polydimethylsiloxanes, polymethylhydrogensiloxanes, polysilsesquioxanes, polytrimethylsiloxanes, polydimethylcyclosiloxanes, and combinations of two or more thereof. Each silicone resin can also contain function groups such as halide, amine, hydroxy, epoxy, carbinol, carboxylate, acetoxy, alkoxy, acrylate, and combinations of two or more thereof. The molecular weight can be in the range of from about 500 to about 1,000,000.

When polymeric, the silicone rubber may be a copolymer of one or more comonomers that do not include silicon, such as, for example, ethylene or a comonomer including a vinyl group.

Silicone rubber may optionally contain up to 50 wt % of one or more silica fillers. Independently and also optionally, the silicone rubber may be blended with up to 90 wt % of one or more carriers or binder resins to facilitate the ease of handling in the pellet form.

Preferably, the viscosity of the silicone rubber is between about 600 to about 300×10⁵ centipoise at 25° C.

Particularly preferred silicone rubbers include, without limitation, polydimethylsiloxanes and copolymers of ethylene and vinyl dimethylsiloxanes, which are widely available on a commercial basis.

Several preferred silicone rubbers for use in the present invention are commercially available. These include, for example, MB50-002 masterbatch material, available from the Dow Corning Corporation of Midland, Mich., which includes 50% silicone rubber in a carrier of low density polyethylene. They are also available from General Electric, Fairfield, Conn.

Preferably, the composition comprises a finite amount up to about 60 wt % of the silicone rubber, based on the weight of the composition. More preferably, the composition of the invention comprises from about 1 up to about 50%, or to about 40%, or to about 30 wt % of the silicone rubber based on the weight of the composition. More preferably, the composition comprises from about 2 wt % to about 25 wt % of the silicone rubber. Of note are compositions in which the silicone rubber is present at a level of greater than 4 wt %, based on the total weight of the composition.

The composition of the invention also includes one or more metal compounds. Suitable metal compounds can include, without limitation, any metal compound that is stable to air, water, the other components of the composition of the invention, and the processing conditions to make the composition of the invention. In the case where two metal compounds are present in the composition, one of the two metal compounds can be an inorganic filler, and the other of the two metal compounds can be a metal hydroxide or hydrated metal compound, such as metal oxide.

Suitable inorganic fillers include, without limitation, one or more of: feldspars including orthoclase, microcline, anorthite, and albite; clays including kaolin; talc; silica; alumina; gypsum; aluminosilicates including zeolites; metal carbonates; metal sulfates; ceramic microspheres; mica; nepheline syenite; and the like.

Preferred inorganic fillers are selected from the group consisting of metal carbonates, and more preferred are carbonates of divalent metal ions, such as magnesium, calcium, and zinc, for example. Still more preferred is calcium carbonate or magnesium carbonate.

The term “metal hydroxide or hydrated metal compound”, as used herein, includes hydrated or anhydrous metal hydroxides, hydrated or anhydrous metal oxyhydrides, and hydrated metal oxides. Moreover, a “metal hydroxide or hydrated metal oxide” may refer to a single metal compound or to a combination of two or more metal compounds. Suitable metal hydroxides and hydrated metal oxides include, without limitation, one or more hydroxides or hydrated oxides of metals included in groups 2 through 15, inclusive, of the periodic table.

Preferred metal compound include, without limitation, one or more divalent or trivalent metal ions, or hydrates of aluminum oxide, such as aluminum oxide trihydrate, magnesium hydroxide, aluminum trihydroxide (Al(OH)₃), and boric acid, for example. More preferred hydrated metal oxides include alumina trihydrate.

Any commercially available grade of the inorganic fillers and metal hydroxides or hydrated metal oxides set forth above is suitable for use in the present invention, provided that its particle size distribution is appropriate for processing with the other components of the composition.

Preferred inorganic fillers that are commercially available include Albaglos™ (0.7 micron CaCO₃), available from Specialty Minerals, Inc., of Bethlehem, Pa., and the like.

Preferred metal hydroxides that are commercially available include MAGNIFIN™ H-10, available from Magnesiaprodukte GmbH & Co. KG of Breitenau am Hochlantsch, Austria, and MagShield™ S, available from Martin Marietta Magnesia Specialties of Raleigh, N.C., and the like.

The composition of the invention can comprise from about 30 wt % to about 80 wt %, or about 40 wt % to about 70 wt %, or about 45 wt % to about 65 wt %, of the metal compound, based on the weight of the composition.

When one of the metal compounds is an inorganic filler, and the other of the metal compounds is a metal hydroxide or hydrated metal oxide, it is preferable that the inorganic filler be present in a finite amount (or “finite value”, an amount that is not zero).

Of special note are compositions of the invention in which the ratio of the weight of the inorganic filler to the weight of the metal hydroxide or the hydrated metal oxide is less than, with increasing preference in the order given, 90:10; 80:20; 70:30; 60:40; 50:50; 40:60; 30:70; 20:80; 10:90; and 5:95.

The weight ratio of inorganic filler to metal compound can be in the range of from about 0.001:1 to about 1:1. Alternatively, the ratio can be in the range of from about 5:95 or 0.05:1 to about 1:1, or about 0.1;1 to about 1:1, or about 0.1:1 to about 1:2.

Alternatively the inorganic filler can be present in a finite amount up to 30 wt %, alternatively 5 to 30 wt %, and the metal compound can be present in an amount between 70 wt % and 100 wt %, alternatively 70 to 95 wt %, based on the combined weight of the inorganic filler and the metal compound.

Optionally, the composition also includes one or more additional metal oxides, which may be anhydrous or hydrated. Suitable additional metal oxides include, without limitation, the oxide of any element selected from groups 2 through 15 of the Periodic Table of the Elements (CRC Handbook of Chemistry and Physics, 67^{th} edition, 1986, CRC Press, Boca Raton, Fla.), provided that the additional metal oxide is stable to air, water, the other components of the composition of the invention, and the processing conditions to make the composition of the invention. Preferred examples of the additional metal oxide or oxides include, without limitation, iron oxides (such as Fe₂O₃) and titanium dioxide (TiO₂), and more preferably the additional metal oxide or oxides comprise titanium dioxide.

Any commercially available grade of the additional metal oxide or oxides is suitable for use, preferably its particle size distribution is appropriate for processing with the other components of the composition. Preferably, the composition comprises less than about 10 wt % of the additional metal oxide or oxides, based on the weight of the composition. More preferably, the composition comprises less than about 5 wt % of the additional metal oxide or oxides, based on the weight of the composition. Still more preferably, the composition comprises less than about 3 wt % of the additional metal oxide or oxides, based on the weight of the composition.

The composition may also include a small amount (e.g., 0.001 wt % and up) of a metal stearate, preferably magnesium stearate. Preferably, the composition of the invention comprises less than about 5 wt % of the metal stearate, and more preferably less than about 2 wt %, based on the weight of the composition.

The composition may also include such additives as are commonly used in materials. These additives include plasticizers, processing aids, coupling agent, compatibilizers, pigments, colorants, chopped fibers, color crunchies, etc. Suitable levels of these additives and methods of incorporating these additives into polymer compositions are known to those of skill in the art. See, e.g., “Modern Plastics Encyclopedia”, McGraw-Hill, New York, N.Y. 1995.

The composition has a limiting oxygen index (LOI) value of greater than about 21, preferably greater than 35 or greater than 40. LOI is a measurement of the minimum percentage of oxygen in a flowing mixture of oxygen and nitrogen that supports combustion of a test material.

To form the composition, the individual components may be blended by any suitable means known in the art. The blending process may be a batch or a continuous process. For example, the individual materials can be mixed with each other in a polymer in molten form, such as by melt blending in an extruder. Alternatively, the individual materials can be blended with each other in a high shear mixing device, such as a two-roll mill or a Banbury mixer.

Also provided is a product comprising, or produced from, a substrate having coated, encased, impregnated, laminated, coextruded, calendered, or applied, thereon or therewith the composition disclosed herein. The substrate can be foam, plastics, metal (particularly aluminum), fabrics, paper, tile, wood, coating, fiber, leather, or combinations of two or more thereof. These substrates can be used to make a wide variety of products or materials including, without limitation, flooring, ceiling, wall panel, building panel, construction, coatings, furniture (furnishings of a building, including seating, tables, cabinets, toys and decorative objects, mats and carpets, and the like), cabinetry, containers, and decorative products.

Products may be made flame resistant or retardant according to methods that are well known in the art. For example, after mixing the components of the composition in an extruder, the composition is a melt that may be shaped by injection molding, casting, melt extrusion, flat die extrusion, lamination, calendaring, protrusion, or any other technique that will produce the desired shape. The composition may also be formed into fibers and filaments by methods well known in the art, such as spinning, extrusion, cold drawing, and the like. See, e.g., U.S. Pat. No. 2,418,492. When solidified, the composition may be shaped by grinding, milling, carving, or the like. All products disclosed here may include the composition of the invention as one or more of a blended ingredient, a dispersed ingredient, a coating, a layer, a fastened product, or a component of a fastened product.

The term “flame retardant” is synonymous with “flame resistant” and “fire resistant” and refers to the property of resisting ignition or combustion in air. Any decrease in the flammability of a material, when compared to a conventional material, is included in the definition of “flame retardant”.

The composition may be used alone, or it may be combined with other materials to form flame resistant products. Replacing even a portion of flammable material in a conventional product with the composition is expected to enhance the flame resistance of the product.

When the composition is combined with other materials, the combination may be a uniform mixture, such as a polymer blend, or a non-uniform mixture, such as a dispersion. For example, the composition may be formed into particles and incorporated, as particles that keep their integrity, into another polymeric material. A combination according to the invention may also include a laminated structure or an over-molded structure. A combination may also be formed by permanently or reversibly fastening two or more objects, at least one of which comprises the composition disclosed herein.

Preferably, the compositions may be included in a foam. In one example of a process to generate the voids that define a foam, the composition of the invention may be combined with a blowing agent, and then heated to decompose or volatilize the blowing agent.

A foam comprising the composition may preferably be crosslinked to the degree that is necessary to develop an appropriate stiffness for use in certain products. Crosslinking may be accomplished by, for example, reacting the organic polymer with a crosslinking agent, such as peroxides, silane containing polymer, irridation treatment, and the like.

Foams provide a useful morphology and many flame resistant products may include the compositions as a foam. Of note are insulation, cushions for furniture, and cushioned layers for flooring, and the like.

The compositions disclosed here may be used to make construction materials or wire and cable applications. Wire and cable refer to any use or application of polymer products to enable or improve the transmission of voice, data, image, or electrical power ranging from about a millivolt to about several hundred kilovolts via any type of conductor such as, without limitation, metal, glass, semiconductors, polymers, and the like. The products and methods disclosed herein are within the scope of the invention, whether they are used as construction materials, in wire and cable applications, or in a different context. Construction material refers to any object or material that is included in the structure of buildings, whether commercial or residential; vehicles, such as automobiles, buses, trucks, airplanes, trains, and ships; and infrastructure, such as roads, tunnels, and bridges.

Examples of suitable construction materials whose flame resistance may be increased by at least partial fabrication from a composition disclosed here include, without limitation, flooring, roofing, ceilings, walls and building panels, insulation, conduit, wooden products such as fixtures, beams and window frames, plastic products such as pipes, and the like, and decorative component(s) or layer(s).

Examples of suitable wire and cable applications include, for example, insulation, shielding, bedding, jacketing, sheathing, or any type of coating, and specific cable construction elements such as tubes, slotted cores, buffers, tapes, conduits, connectors, and housings. Wire and cable applications may be part of a fixed or mobile installation, rigid or flexible, aerial, on ground, or under ground, underwater including subsea, indoor or outdoor, and part of any type of vehicle, e.g., ground or underground transportation, air, space, water or underwater, including subsea.

Plastic products, such as pipes, fan shrouds, and floor mats, may be made from the composition, which is capable of being formed by means that are well known in the art for forming plastic products.

Wooden products, including plywood and particle board, may be rendered flame resistant by coating, encasing, lamination, or impregnation with the composition of the invention. Alternatively, one or more components of a wooden product, such as, e.g., one or more layers of the plywood, or a portion of the wood chips and/or binder of the particle board, may be replaced the composition of the invention.

The composition may be used included in walls. Typically, walls are constructed from plywood, particle board, dry wall, or building panels, with wooden or metal support structures. The flame resistance of plywood and particle board may be enhanced using the compositions and methods disclosed here.

Dry wall usually includes a core layer of plaster or gypsum that is covered by two outer layers of paper or cardboard. A layer of adhesive may be disposed between the core of the dry wall and one or more of the outer layers.

Building panels, which are common exterior and interior decorative construction material in modern commercial and residential buildings, are generally constructed of a core layer that is covered by two outer layers of sheet metal, typically aluminum. Building panels offer many advantages to designers and architects, including economically advantageous fabrication costs, flexibility that enables the panels to be incorporated into curved structures, and various desirable color and finishing effects that can be achieved with the metal outer layers. A layer of adhesive may be disposed between the core of the building panel and one or more of the outer layers.

The composition may be included in the core or core sheet of the dry wall or building panel. Preferably, the composition is present as foam. The composition may also be included in a dry wall sheet or in a building panel as one or more of a blended ingredient, a dispersed ingredient, a coating, a layer, a fastened product, or a component of a fastened product.

The composition can be included in ceilings, including ceiling tiles. Ceilings may be made of plywood, particle board, dry wall or building panels. The flame resistance of dry wall, plywood, particle board, and building panels may be enhanced using the compositions and methods disclosed here. Ceiling tiles are typically made of compressed fibers adhered with a binder, and may also include a decorative surface layer that is laminated or coated onto the bulk of the tile. When used in ceiling tiles, the composition may be included in or substituted for at least a portion of the fibers, at least a portion of the binder, as a coating, or in a combination of one or more of the fibers, the binder, and the coating.

Roofing materials, such as sheets and shingles, can include the composition of the invention. The composition may be included in or substituted for tar, asphalt or another material conventionally used to waterproof the roofing material. The composition of the invention may also be included in or substituted for a material used to adhere decorative granules to the roofing material. The decorative granules may also comprise the composition of the invention.

The composition of the invention may be shaped into foams or fibers, which are morphologies that are usual for insulating materials. Alternatively, the composition of the invention may be mixed with another insulation material or partially substituted for another insulation material to enhance its flame resistance.

Flooring, whether in flexible sheet form or in stiffer tile form, is either a single layer or made by laminating or co-extruding several layers, such as an adhesive layer, a core layer that promotes flooring integrity, a cushion layer, and a surface layer that is preferably adapted to withstand wear from foot traffic and may also have decorative features. Preferably, a flame resistant flooring comprises at least one layer comprising the composition of the invention, such as the back layer of the floor tiles. The flame resistant layer may be included as an additional layer in the flooring. Alternatively, the flame resistant layer may result from the adaptation of one of the conventional flooring layers, such as a foam cushion layer, for example, to include the composition of the invention.

The product disclosed can be used in applications disclosed hereinincluding, for example, flooring, wall panel, or building panel. The product can include one or more layers that comprises or is produced from wood, plastics, adhesive, metal, fabric (e.g., glass, woven, or nonwoven), print sheet, clear surface sheet, or film. The layer or layers optionally comprises the composition disclosed herein.

A coating comprising the composition may be applied as a melt, or as a suspension in a solvent that dissolves the polymeric and/or silicone rubber components of the composition. Alternatively, the coating may be a powder coating or other industrial coating that is, e.g., suited for application to steel structures.

Alternatively, the composition may be dispersed in a mixture of solvents and/or plasticizers that is analogous to water based paints and coatings. Typically, a water based paint or coating includes a film-forming latex polymer, a solvent that boils at a relatively low temperature (water, e.g.), and at least one solvent that boils at a relatively high temperature (butyl carbitol, e.g.) and acts as a solvent and/or plasticizer to promote the formation of a film from the discrete particles of latex polymer.

The composition may be reduced to a small particle size suitable for use in water based paints or coatings by any means known in the art, such as grinding, for example. The small particles may be suspended in a mixture of water and a second, e.g., higher boiling solvent and/or plasticizer, such as dioctyl phthalate, a fatty acid, or a salt of a fatty acid, to produce a flame resistant coating. Alternatively, some or all of the film forming polymer in a conventional water based or solvent based coating may be replaced with the composition of the invention, also resulting in a flame resistant coating.

Additives that are conventionally used in paints and coatings may also be useful in the coatings of the invention. Suitable levels of these additives and methods of incorporating additives into polymer compositions are known to those of skill in the art. See, e.g., “Paint Flow and Pigment Dispersion by Temple C. Patton (2^{nd} ed., John Wiley & Sons, 1979).

Products that may be rendered flame resistant by at least partial coating with a coating of the invention include products made from any flammable material. Examples of flammable materials include, without limitation, wood, plastics, fabrics, leather, papers, cardboards, and the like.

Also disclosed is a floor tile or sheet that comprises, consists essentially of, consists of, or is produced from, a composition. The composition can be the same as disclosed above.

The following examples are provided to describe the invention in further detail. These examples, which set forth a preferred mode presently contemplated for carrying out the invention, are intended to illustrate and not to limit the invention.

### EXAMPLES

The melt index (MI) values reported herein were measured according to ASTM D1238 (190° C./2.16 kg), unless otherwise noted. The UL-94 protocols, which were followed herein for horizontal and vertical burning tests, unless otherwise noted, are available from Underwriters' Laboratories, Inc., of Northbrook, Ill. The LOI values herein were measured according to ASTM D2863.

In each of the compositions listed in Table 1, below, the polymer is a copolymer of ethylene with butyl acrylate in a weight ratio of 83/17. The silicone rubber is MB50-002 masterbatch material, available from the Dow Corning, which includes 50% silicone rubber in a carrier of low density polyethylene. The calcium carbonate is Albaglos™ (0.7 micron), available from Specialty Minerals, Inc., of Bethlehem, Pa. The magnesium hydroxide is MAGNIFIN™ H-10, available from Magnesiaprodukte GmbH & Co. G of Breitenau am Hochlantsch, Austria, or MagShield™ S, available from Martin Marietta Magnesia Specialties of Raleigh, N.C.

The ingredients were metered into a 30 mm twin screw extruder. The feed rate of each individual ingredient was proportional to the final concentration of that ingredient in the compound. The compounds were then molded into test pieces for the limiting oxygen index measurement of each composition according to the standard procedures set forth above. The results are summarized in Table 1, below.

TABLE 1
Compositions and Test Results*

| | | Silicone | | | | |
|---|---|---|---|---|---|---|
| Example | Polymer | Masterbatch | CaCO₃ | Mg(OH)₂ | MI at 190° C. | LOI (% O₂) |
| C1 | 40 | 20 | 40 | 0 | 1.6 | 29.4 |
| 1 | 40 | 20 | 20 | 20 | 1.9 | 38.6 |
| 2 | 40 | 20 | 0 | 40 | 2.1 | 37.0 |
| 3 | 32 | 16 | 32 | 20 | 0.45 | 34.1 |
| 4 | 24 | 12 | 24 | 40 | 0.02 | 42.7 |
| 5 | 34 | 11 | 11 | 44 | N/A* | 35.0 |
| 6 | 30 | 10 | 10 | 50 | N/A | 40.4 |
| 7 | 34 | 11 | 11 | 44 | .83 | >40 |
| 8 | 27.4 | 8.8 | 8.8 | 55 | .29 | >40 |
| 9 | 30 | 10 | 10 | 50 | 1.23 | >40 |

*The values shown for polymer, silicone masterbatch, CaCO₃, and Mg(OH)₂ are weight %; N/A means “not available”.

The results obtained from the compositions of Examples 1 through 9 demonstrate that compositions including magnesium hydroxide exhibit LOI values that are significantly higher than the LOI value of Comparative Example C1, a composition that includes calcium carbonate and not magnesium hydroxide. In addition, the comparison of Examples C1, 1 and 2 demonstrates that a composition including both calcium carbonate and magnesium hydroxide exhibits an LOI higher than is obtained by a composition including either calcium carbonate or magnesium hydroxide alone.

In further testing, the composition of Example 4 attained a rating of V-1 to V-0 according to the UL-94 protocol, and most probably passes the horizontal burn test.

What is claimed is:

1. A product comprising or produced from a substrate that is coated, encased, impregnated, laminated, coextruded, calendered, or applied with a composition wherein the substrate is plastics, metal, fabric, paper, wood, leather, or combinations of two or more thereof; the composition comprises an organic polymer, a silicone rubber, a metal compound, and an inorganic filler; and the metal compound is metal hydroxide or hydrated metal compound or both.

2. The product of claim 1 wherein the organic polymer comprises an ethylene copolymer or an ionomer thereof.

3. The product of claim 2 wherein the ethylene copolymer or an ionomer thereof comprises an ethylene/carboxylic acid copolymer or ionomer thereof having from 9 to 25 weight percent acrylic or methacrylic acid, and optionally up to 40 weight percent C₁₋₈ alkyl acrylate or methacrylate.

4. The product of claim 2 wherein the ethylene copolymer or an ionomer thereof comprises or derived from (1) ethylene and (2) (meth)acrylic acid, alkyl (meth)acrylate, vinyl acetate, carbon monoxide, epoxy-containing (meth)acrylate, vinyl silane, maleic anhydride, maleic acid, maleic acid mono-ester, or combinations of two or more thereof.

5. The product of claim 2 wherein the ethylene copolymer or ionomer thereof comprises or derived from acrylic acid or ester or salt thereof, methacrylic acid or ester or salt thereof, or combinations of two or more thereof.

6. The composition of claim 2 wherein the inorganic filler comprises at least one feldspar, clay, talc, silica, alumina, gypsum, aluminosilicate, metal carbonate, metal sulfate, ceramic microsphere, mica, or nepheline syenite.

7. The composition of claim 4 wherein the inorganic filler comprises at least one metal carbonate.

8. The composition of claim 5 wherein the inorganic filler comprises calcium carbonate.

9. The composition of claim 2 wherein the metal compound is one or more hydroxides, oxyhydroxides, and hydrated oxides of divalent and trivalent metal ions.

10. The composition of claim 4 wherein the metal compound is one or more hydroxides, oxyhydroxides, and hydrated oxides of divalent and trivalent metal ions.

11. The composition of claim 6 wherein the metal compound is aluminum trihydroxide, hydrated alumina, alumina trihydrate, magnesium hydroxide, boric acid, or combinations of two or more thereof.

12. The composition of claim 8 wherein the metal compound comprises magnesium hydroxide or alumina trihydrate.

13. A product comprising, or produced from, a substrate that is coated, encased, impregnated, laminated, coextruded, calendered, or applied with a composition wherein
the substrate is plastics, metal, fabrics, paper, wood, leather, or combinations of two or more thereof;
the composition comprises an organic polymer, a silicone rubber, a metal compound, and an inorganic filler;
the organic polymer comprises an ethylene copolymer or an ionomer thereof;
the metal compound is metal hydroxide or hydrated metal compound or both; and
the inorganic filler comprises at least one metal carbonate.

14. The product of claim 13 wherein
the ethylene copolymer or an ionomer thereof the ethylene copolymer or an ionomer thereof comprises or derived from (1) ethylene and (2) (meth)acrylic acid, alkyl(meth)acrylate, vinyl acetate, carbon monoxide, epoxy-containing (meth)acrylate, vinyl silane, maleic anhydride, maleic acid, maleic acid mono-ester, or combinations of two or more thereof;
the metal compound is one or more hydroxides, oxyhydroxides, and hydrated oxides of divalent and trivalent metal ions; and
the inorganic filler comprises at least one feldspar, clay, talc, silica, alumina, gypsum, aluminosilicate, metal carbonate, metal sulfate, ceramic microsphere, mica, or nepheline syenite.

15. The product of claim 13 wherein
the ethylene copolymer or ionomer thereof comprises or derived from ethylene and acrylic acid or ester or salt thereof, methacrylic acid or ester or salt thereof, or combinations of two or more thereof;
the metal compound comprises magnesium hydroxide or alumina trihydrate; and
the inorganic filler comprises calcium carbonate.

16. The product of claim 1, 5, 8, 12, 13, or 15 wherein the substrate is wood and the product is used in application including flooring, ceiling, roofing, wall panel, building panel, insulation, conduit, fixture, beam, frame, or decorative component.

17. The product of claim 1, 5, 8, 12, 13, or 15 wherein the substrate is metal and the product is used in application including flooring, ceiling, roofing, wall panel, building panel, insulation, conduit, fixture, beam, frame, or decorative component.

18. The product of claim 17 wherein the substrate is aluminum.

19. The product of claim 1, 5, 8, 12, 13, or 15 wherein the substrate is plastics and the product is used in application including flooring, ceiling, roofing, wall panel, building panel, insulation, conduit, fixture, beam, frame, fibers, or decorative component.

20. The product of claim 1, 5, 8, 12, 13, or 15 wherein the substrate is paper and the product is used in application including flooring, ceiling, roofing, wall panel, building panel, insulation, conduit, fixture, beam, frame, or decorative component.

21. The product of claim 16 wherein the product is used in application including flooring, wall panel, or building panel and optionally includes one or more layers comprising wood, plastics, adhesive, fabric, or film; and the layer optionally comprises the composition as recited in 16.

22. The product of claim 21 wherein the product includes the layer.

23. The product of claim 18 wherein the product is used in application including wall panel or building panel and optionally includes one or more layers of adhesive, film, or aluminum; and the layer optionally comprises the composition as recited in claim 18.

24. The product of claim 23 wherein the product includes the layer.

25. The product of claim 19 wherein the product is used in application including flooring, wall panel, or building panel and optionally includes one or more layers comprising wood, plastics, adhesive, fabric, or film; and the layer optionally comprises the composition as recited in claim 19.

26. The product of claim 25 wherein the product includes the layer.

27. The product of claim 25 wherein the plastics is used in flooring application.

28. The product of claim 26 wherein the plastics is used in flooring application.

29. A floor tile or sheet consisting essentially of, or produced from, a composition wherein the composition is as recited in claim 1.

30. A composition comprising an organic polymer, a silicone rubber, a metal compound, and an inorganic filler wherein the metal compound is metal hydroxide or hydrated metal compound or both and the weight ratio of the inorganic filler to the metal compound is in the range or from about 5:95 to about 1:1.
